(19) United States
(12) Patent Application Publication
(10) Pub. No.: US 2025/0043911 A1
(43) Pub. Date: Feb. 6, 2025

(54) LUBRICATION SYSTEM AND METHOD

(71) Applicant: SKF Argentina S.A., Tortuguitas (AR)

(72) Inventor: Federico ROLT, Rosario (AR)

(21) Appl. No.: 18/775,159

(22) Filed: Jul. 17, 2024

(30) Foreign Application Priority Data
Aug. 1, 2023 (DE) 102023207370.6

(51) Int. Cl. F16N 29/02; F16N 7/00

(52) U.S. Cl. CPC F16N 29/02; F16N 7/00; F16N 2210/14; F16N 2250/00; F16N 2250/08; F16N 2270/70; F16N 2280/02

(57) ABSTRACT

A lubrication system (1) for lubricating lubrication points (2-1 to 2-8). The lubrication system includes a lubricant reservoir (4), lubricant injectors (6-1 to 6-8) for providing lubricant from the lubricant reservoir to the lubrication points, and a control unit (8) for controlling the flow of lubricant from the lubricant reservoir to the lubricant injectors. The control unit controls the lubricant injectors to simultaneously deliver lubricant to the lubrication points in predefined lubrication cycles (C_{L}). The lubrication system also includes a condition monitoring unit (10) for monitoring the condition of the lubrication points. When the condition monitoring unit determines the condition of at least one of the lubrication points is abnormal, the control unit controls the lubricant injector being associated with the lubrication point having the abnormal condition to individually deliver an additional dose of lubricant to the associated lubrication point.

### CROSS-REFERENCE TO RELATED APPLICATION

This application claims priority to German Application No. 102023207370.6, filed Aug. 1, 2023, the entirety of which is hereby incorporated by reference.

### FIELD

The present disclosure relates to a lubrication system according to claim 1. The present disclosure further relates to a lubrication method according to claim 10.

### BACKGROUND

In most technical fields in which bearings (rolling bearings or plain bearings) are used, the bearings are lubricated for allowing a proper function and long service life of the bearings. In order to maintain a sufficient lubrication, a centralized and automatic lubrication system may be used. Such a system may provide lubricant to several bearings or points of lubrication. In particular, a centralized lubrication system provides a predetermined quantity of lubricant to each of the lubrication points at specific time intervals.

However, when a bearing failure mode is detected, which may be detected using a condition monitoring system, the collected condition monitoring data must be analyzed by an analyst or qualified technician, and he/she determines that lubrication of the bearing is required. Subsequently, he/she must instruct a lubrication technician to manually provide additional lubrication to the appropriate points by use of a grease gun, or by forcing the centralized and automatic lubrication system (ALS) to perform a manual lubrication cycle. In the latter case, forcing a manual lubrication cycle results in unnecessary lubrication of all the bearings that are part of the system as no selective lubrication possible. This is a short-term solution which is repeated perpetually in the plant on a regular basis (often monthly) and consumes many hours of analyst and lubrication technician's time.

Alternatively, the problem may be ignored. This means that the equipment may be over- or under-lubricated during its whole useful life, and in many cases, this will impact, and possibly shortens, the equipment life and might lead to more frequent catastrophic shutdowns and/or unplanned downtime.

It is therefore object of the present disclosure to provide an improved lubrication system which is able to provide a centralized, automatic lubrication while at the same time ensuring that each lubrication point is sufficiently lubricated.

### SUMMARY

This object is solved by a lubrication system for lubricating a plurality of lubrication points according to claim 1 and a lubrication method for lubricating a plurality of lubrication points according to claim 10.

The lubrication system comprises a lubricant reservoir, a plurality of lubricant injectors for providing lubricant from the lubricant reservoir to the plurality of lubrication points, for example bearings, and a control unit for controlling the flow of lubricant from the lubricant reservoir to the plurality of lubricant injectors. The lubricant may be any kind of lubricant, for example grease or oil. The plurality of lubrication points may be any number of lubrication points.

The control unit is configured to control the plurality of lubricant injectors to simultaneously deliver lubricant to the plurality of lubrication points in predefined lubrication cycles. In each lubrication cycle, a predetermined amount or quantity of lubricant is supplied to each injector and then delivered to each point of lubrication or bearing. The control unit may be any kind of unit which is able to control the supply of lubricant from the reservoir to the injectors and then to the lubrication points. The control unit may be implemented in the lubrication system or may be implemented remote, for example on a server or a remote computing system.

In order to provide an improved lubrication of each of the lubrication points, the lubrication system further comprises a condition monitoring unit for monitoring the condition of the plurality of lubrication points. For example, the condition monitoring unit may monitor the condition of the lubrication of the lubrication points, for example bearings, via monitoring parameters. When the condition monitoring unit determines that the condition of at least one of the plurality of lubrication points is abnormal (for example having a vibration and/or temperature being too high which may indicate an insufficient lubrication), the control unit is configured to control the lubricant injector being associated with the lubrication point having an abnormal condition to individually deliver an additional dose of lubricant to the lubrication point having an abnormal condition. Thus, in addition to the automatic lubrication in specific lubrication cycles, one or more of the lubrication points may additionally be lubricated when the condition of the lubrication point requires such an additional lubrication.

According to an embodiment, the control unit is configured to deliver the additional dose of lubricant to the lubrication point having an abnormal condition outside the predefined lubrication cycles. During the predefined lubrication cycles, the predefined amount or quantity of lubricant is delivered to all lubrication points. Outside of these predefined lubrication cycles, only the lubrication point which needs additional lubrication might be lubricated based on the currently monitored condition of the lubrication point.

According to a further embodiment, the condition monitoring unit comprises at least one sensor for each lubrication point of the plurality of lubrication points, wherein at least one condition detection parameter is configured per sensor of the respective lubrication point being indicative for a condition of the lubrication point. Preferably, the sensor may measure at least more than one parameter. Measuring more than one parameter may provide an improved knowledge of the condition of the lubrication points, particularly whether the condition of the lubrication point is normal or deviates from the normal condition (in which the lubrication point, e.g., bearing, functions properly) and is in an abnormal condition. The at least one parameter may include for example the temperature and/or vibration of the lubrication point. Further, the sensors may be appropriate sensors like a temperature sensor, a vibration sensor, an ultrasound sensor, a displacement sensor, and the like.

According to a further embodiment, the condition monitoring unit is configured to compare the value of the monitored parameter with a predefined threshold and is configured to determine that the condition of the respective lubrication point is abnormal when the value of the monitored parameter exceeds the predefined threshold. For example, when the monitored parameter is a temperature of the lubrication point and the temperature raises and exceeds a predefined threshold temperature, this may indicate an abnormal condition of the respective lubrication point.

According to a further embodiment, the condition monitoring unit is configured to monitor the plurality of lubrication points continuously. Thus, an abnormal condition of the lubrication points may be determined immediately, and a corresponding additional dose of lubricant may be prompted accordingly. Alternatively, the condition monitoring unit may monitor the plurality of lubrication points in specific intervals. Such an embodiment may provide the advantage of proactively and automatically reacting due to the reduced monitoring time.

According to a further embodiment, the control unit is configured to individually control each of the plurality of lubricant injectors to stop the transport of lubricant to the plurality of lubrication points outside the predefined lubrication cycles and to deliver an additional dose of lubricant to the lubrication point having an abnormal condition if required. This controlled supply of lubricant may be achieved by providing a stop element to each lubricant injector. Such a stop element may be configured to allow or prevent a lubricant flow from the injector to the lubrication point. For example, the stop element of each of the plurality of lubricant injectors may comprise a valve which is configured to be closed or opened by the control unit. Such a valve may be for example a magnetic or solenoid valve.

According to a further embodiment, the control unit is configured to adjust the predefined lubrication cycles when the control unit determines over a predetermined time period that all lubrication points of the plurality of lubrication points require additional doses of lubricant outside the predefined lubrication cycle. This may provide the advantage that, in addition to the additional delivery of lubricant, also the already existing lubrication cycles may be amended based on the monitored conditions of the lubrication points. This may further improve and enhance the service life of the lubrication points, for example bearings.

According to a further aspect, a lubrication method for lubricating a plurality of lubrication points is suggested. The method comprises the following steps: controlling a plurality of lubricant injectors to deliver lubricant from a lubricant reservoir to a plurality of lubrication points in predefined lubrication cycles, monitoring the condition of the plurality of lubrication points, and, when it is determined that the condition of at least one of the plurality of lubrication points is abnormal, controlling the lubricant injector being associated with the at least one of the plurality of lubrication points to deliver an additional dose of lubricant to the at least one of the plurality of bearings.

An even further aspect of the present disclosure relates to a computer program product comprising a computer program code which is adapted to prompt a control unit, e.g., a computer, and/or a computer of the above discussed lubrication system to perform the above discussed steps.

The computer program product may be a provided as memory device, such as a memory card, USB stick, CD-ROM, DVD and/or may be a file which may be downloaded from a server, particularly a remote server, in a network. The network may be a wireless communication network for transferring the file with the computer program product.

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE DRAWINGS

In the following, preferred embodiments of the present disclosure are described in relation to the drawings, wherein the drawings are exemplarily only, and are not intended to limit the scope of protection. The scope of protection is defined by the accompanied claims, only.

The figures show:

FIG. 1: a schematic view of a lubrication system; and

FIG. 2: a diagram illustrating the lubrication cycles of the lubrication system of FIG. 1.

### DETAILED DESCRIPTION

In the following same or similar functioning elements are indicated with the same reference numerals.

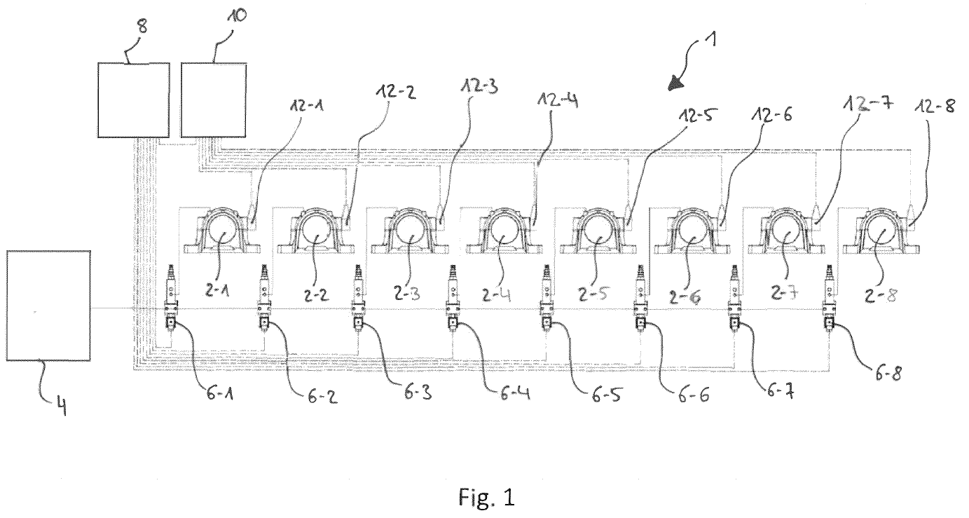

FIG. 1 shows a lubrication system 1. The lubrication system 1 is configured to lubricate a plurality of lubrication points 2-1, 2-2, 2-3, 2-4, 2-5, 2-6, 2-7, 2-8. The lubrication points 2-1, 2-2, 2-3, 2-4, 2-5, 2-6, 2-7, 2-8 may be for example bearings. In FIG. 1, the bearings are shown as ball bearings but may also be any other kind of bearing, for example any other kind of rolling bearings like roller or angular contact ball bearings or plain bearings without any rolling elements.

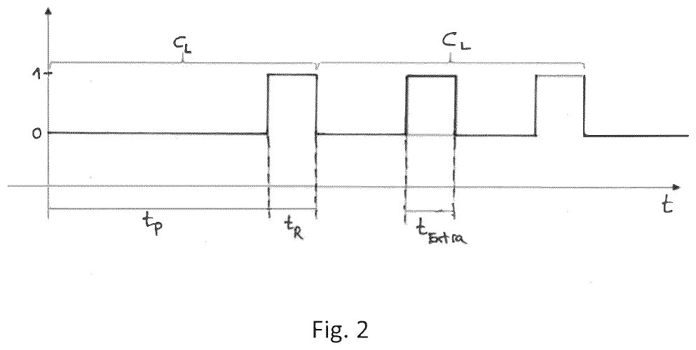

The lubrication system 1 comprises a lubricant reservoir 4 which may be combined with a pressure valve, forming a pump unit. The lubrication reservoir 4 comprises a lubricant like oil or grease. Further, the lubrication system 1 comprises a plurality of lubricant injectors 6-1, 6-2, 6-3, 6-4, 6-5, 6-6, 6-7, 6-8, which are configured to provide lubricant from the pump unit 4 to the plurality of lubrication points 2-1, 2-2, 2-3, 2-4, 2-5, 2-6, 2-7, 2-8. The flow of lubricant is controlled by a control unit 8. Particularly, the control unit 8 is configured to control the plurality of lubricant injectors 6-1, 6-2, 6-3, 6-4, 6-5, 6-6, 6-7, 6-8 to simultaneously deliver lubricant to the plurality of lubrication points 2-1, 2-2, 2-3, 2-4, 2-5, 2-6, 2-7, 2-8) in predefined lubrication cycles (C_{L}, shown in FIG. 2 and explained below in further detail). The delivery of lubricant in predefined lubrication cycles implements an automatic and centralized lubrication of the lubrication points 2-1, 2-2, 2-3, 2-4, 2-5, 2-6, 2-7, 2-8. The predefined lubrication cycles may be defined beforehand based on application considerations, like the typical amount of lubricant and intervals the lubrication points 2-1, 2-2, 2-3, 2-4, 2-5, 2-6, 2-7, 2-8 will require re-lubrication.

In addition, the lubrication system 1 further comprises a condition monitoring unit 10 for monitoring the condition of the plurality of lubrication points 2-1, 2-2, 2-3, 2-4, 2-5, 2-6, 2-7, 2-8. The condition monitoring unit 10 may comprise a plurality of sensors 12-1, 12-2, 12-3, 12-4, 12-5, 12-6, 12-7, 12-8 which are able to measure at least one parameter of each of the lubrication points 2-1, 2-2, 2-3, 2-4, 2-5, 2-6, 2-7, 2-8. The parameters may be any kind of parameter being suitable for assessing the lubrication point condition or state of the respective lubrication point 2-1, 2-2, 2-3, 2-4, 2-5, 2-6, 2-7, 2-8.

The condition monitoring unit 10 may determine, for example based on the measured parameters, that the condition of at least one of the plurality of lubrication points 2-1, 2-2, 2-3, 2-4, 2-5, 2-6, 2-7, 2-8 is abnormal. This may be the case for example when the temperature as the measured parameter exceeds a predefined threshold.

In case one or more of the lubrication points 2-1, 2-2, 2-3, 2-4, 2-5, 2-6, 2-7, 2-8 is determined as to be abnormal, the control unit 8 is configured to control the lubricant injector 6-1, 6-2, 6-3, 6-4, 6-5, 6-6, 6-7, 6-8 being associated with the lubrication point or points 2-1, 2-2, 2-3, 2-4, 2-5, 2-6, 2-7, 2-8 being in the abnormal state or condition to individually deliver an additional dose of lubricant to the associated lubrication point or points 2-1, 2-2, 2-3, 2-4, 2-5, 2-6, 2-7, 2-8.

The lubrication system 1 may use a close to real-time monitoring for assessing the lubrication condition of the lubrication points 2-1, 2-2, 2-3, 2-4, 2-5, 2-6, 2-7, 2-8. The assessment may be based on one or more parameters like vibration, temperature, ultrasound, or the like, as described above. When an abnormal condition associated with one of the lubrication points 2-1, 2-2, 2-3, 2-4, 2-5, 2-6, 2-7, 2-8 is detected, the control unit 8 will trigger an extra lubricant dose to the specific lubrication point/bearing 2-1, 2-2, 2-3, 2-4, 2-5, 2-6, 2-7, 2-8, without modifying its standard lubrication cycle.

Further, after each extra lubrication dose, the control unit 8 may re-assess the lubrication condition of the re-lubricated lubrication point 2-1, 2-2, 2-3, 2-4, 2-5, 2-6, 2-7, 2-8 to determine if another extra lubrication dose is required. The lubrication system 1 can be configured to have a predetermined number of extra lubricant doses or to continue lubricating until the abnormal condition is cleared by the lubrication system 1. Further, all other lubrication points 2-1, 2-2, 2-3, 2-4, 2-5, 2-6, 2-7, 2-8 may also be constantly monitored and re-lubricated when necessary.

The lubrication system 1 may store the lubrication point condition(s) and system operational conditions for post-processing, trending, and analysis. For example, for the purpose to adjust the predefined lubrication cycles when necessary.

In this context it should be noted that the injectors 6-1, 6-2, 6-3, 6-4, 6-5, 6-6, 6-7, 6-8 each can provide a predefined amount or dose of lubricant. Further, a pump (not shown) may be used for supplying the lubricant from the pump unit 4 to the injectors 6-1, 6-2, 6-3, 6-4, 6-5, 6-6, 6-7, 6-8. Each of the injectors 6-1, 6-2, 6-3, 6-4, 6-5, 6-6, 6-7, 6-8 may have a valve, for example a solenoid to allow or prevent lubricant flow from the injector 6-1, 6-2, 6-3, 6-4, 6-5, 6-6, 6-7, 6-8 to the lubrication points 2-1, 2-2, 2-3, 2-4, 2-5, 2-6, 2-7, 2-8.

FIG. 2 shows a diagram illustrating a lubrication cycle C_{L}, where the x axis corresponds to the time and the y axis corresponds to the amount of delivered lubricant (0 means no lubricant is delivered and 1 means that a predefined amount or dose of lubricant is delivered). As can be seen in FIG. 2, the lubrication system 1 is an automatic lubrication system which runs a standard lubrication cycle C_{L} (having a run time t_{P} during which lubricant is delivered to all lubrication points 2-1, 2-2, 2-3, 2-4, 2-5, 2-6, 2-7, 2-8 and a pause time t_{P} during which no lubricant is delivered). When the control unit 8 of the lubrication system 1 receives condition monitoring signals via the condition monitoring unit 10 and the sensors 12-1, 12-2, 12-3, 12-4, 12-5, 12-6, 12-7, 12-8 which indicate that a specific lubrication point 2-1, 2-2, 2-3, 2-4, 2-5, 2-6, 2-7, 2-8 needs additional lubrication, a selective lubrication may be carried out as explained above. Selective lubrication means that the control unit 8 reacts by providing an additional lubrication dose which is isolated to only the lubrication point(s) 2-1, 2-2, 2-3, 2-4, 2-5, 2-6, 2-7, 2-8 which need(s) additional lubrication. This additional lubrication occurs at a time t_{Extra} during the regularly scheduled pause time t_{P} for the rest of the lubrication points 2-1, 2-2, 2-3, 2-4, 2-5, 2-6, 2-7, 2-8. At the same time, it does not alter the standard lubrication cycle C_{L}.

In the following, an example sequence of lubrication steps is described. During normal operation, the control unit 8 runs a typical lubrication cycle C_{L}. (standard lubrication cycle), which consists of an amount of the expected run time t_{R} and a typically much longer pause time t_{P}. The control unit 8 completes this cycle continuously to deliver grease to all lubrication points 2-1, 2-2, 2-3, 2-4, 2-5, 2-6, 2-7, 2-8. When an abnormal under-lubrication condition is detected, this condition (alarm status) of only the affected bearing or lubrication point 2-1, 2-2, 2-3, 2-4, 2-5, 2-6, 2-7, 2-8 is communicated to the control unit 8. During the pause time t_{P} of the standard cycle C_{L}, the control unit 8 closes all injector valves except for the affected lubrication point or points 2-1, 2-2, 2-3, 2-4, 2-5, 2-6, 2-7, 2-8 and initiates an extra lubrication dose for the affected lubrication point or points 2-1, 2-2, 2-3, 2-4, 2-5, 2-6, 2-7, 2-8. The extra lubrication t_{Extra} is completed inside of the overall pause time t_{P}. When the overall pause time t_{P} is over and the run time t_{P} begins, all lubrication points 2-1, 2-2, 2-3, 2-4, 2-5, 2-6, 2-7, 2-8 will be lubricated. This extra lubrication can continue through multiple lubrication cycle time intervals C_{L} if the under-lubrication condition persists. In practice, it is typically only necessary for 1-2 extra lubrications during normal operation. When a bearing or lubrication point 2-1, 2-2, 2-3, 2-4, 2-5, 2-6, 2-7, 2-8 is damaged, a long-term demand for extra lubrication may be expected and these may be programmed via the control unit 8.

In summary, the herein described lubrication system provides an improved lubrication of different kind of lubrication points, for example bearings, by a combination of an automatic, centralized lubrication at predetermined lubrication cycles and an additional lubrication at specific, individual lubrication times for lubrication points requiring an additional lubrication. The lubrication system successfully combines predictive maintenance with lubrication automation, resulting in a lubrication system that modifies its cycle according to the bearing or lubrication point condition.

The lubrication system may be particularly suitable for critical applications, helping to avoid unscheduled machine shutdowns caused by lubrication system issues and bearing faults. As additional lubricant is provided when specific monitoring parameter levels surpass alert thresholds, the extra lubrication can help to slow down the degradation of the respective bearings or lubrication points. The automation of additional lubrication makes manual intervention unnecessary and contributes to worker safety. Critical asset runnability may be extended and/or unplanned shutdown may be eliminated due to the ability of the automatic extra lubrication when necessary. Further, as the additional lubricant is only delivered to lubrication points which require the additional lubrication, the overall lubricant consumption may be reduced (when compared to manual lubrication) because it adds more lubricant only after confirmation that more lubricant is needed and preferably only lubricates the point that requires it and not all the injectors connected to the same line.

### REFERENCE NUMERALS

1 Lubrication system
2-1 to 2-8 bearing/lubrication point
4 lubricant reservoir/pump unit consisting of a reservoir and a pressure valve
6-1 to 6-8 lubricant injector
8 control unit
10 condition monitoring unit
12-1 to 12-8 sensor
C_{L} lubrication cycle
t_{P} pause time
t_{R} run time
t_{Extra} additional lubrication time

What is claimed is:

1. A lubrication system for lubricating a plurality of lubrication points, the lubrication system comprising:
a lubricant reservoir;
a plurality of lubricant injectors for providing lubricant from the lubricant reservoir to the plurality of lubrication points;
a control unit for controlling the flow of lubricant from the lubricant reservoir to the plurality of lubricant injectors, the control unit being configured to control the plurality of lubricant injectors to simultaneously deliver lubricant to the plurality of lubrication points in predefined lubrication cycles); and
a condition monitoring unit for monitoring the condition of the plurality of lubrication points, the condition monitoring unit being configured to determine when the condition of at least one of the plurality of lubrication points is abnormal, the control unit being configured to control the lubricant injector associated with said one lubrication point having an abnormal condition to individually deliver an additional dose of lubricant to the corresponding said one lubrication point when the condition monitoring unit determines the condition of said one lubrication point is abnormal.

2. The lubrication system according to claim 1, wherein the control unit is configured to deliver the additional dose of lubricant to the lubrication point having the abnormal condition outside the predefined lubrication cycles.

3. The lubrication system according to claim 1, wherein the condition monitoring unit comprises at least one sensor for each bearing of the plurality of lubrication points, wherein the at least one sensor is configured to monitor at least one parameter of the respective lubrication point being indicative for an abnormal condition of the lubrication point.

4. The lubrication system according to claim 3, wherein the lubrication point is a bearing and wherein the at least one parameter includes temperature and/or vibration of the bearing.

5. The lubrication system according to claim 3, wherein the condition monitoring unit is configured to compare the value of the monitored parameter with a predefined threshold and is configured to determine that the condition of the respective lubrication point is abnormal when the value of the monitored parameter exceeds the predefined threshold.

6. The lubrication system according to claim 1, wherein the condition monitoring unit is configured to monitor the plurality of lubrication points continuously.

7. The lubrication system according to claim 1, wherein the control unit is configured to individually control each of the plurality of lubricant injectors to stop the transport of lubricant to the plurality of lubrication points outside the predefined lubrication cycles and to deliver an additional dose of lubricant to the lubrication point having an abnormal condition if required.

8. The lubrication system according to claim 7, wherein each of the plurality of lubricant injectors comprises a valve which is configured to be closed or opened by the control unit.

9. The lubrication system according to claim 1, wherein the control unit is configured to adjust the predefined lubrication cycles when the control unit determines over a predetermined time period that all lubrication points of the plurality of lubrication points require additional doses of lubricant outside the predefined lubrication cycle.

10. The lubrication system according to claim 2, wherein the condition monitoring unit comprises at least one sensor for each bearing of the plurality of lubrication points, wherein the at least one sensor is configured to monitor at least one parameter of the respective lubrication point being indicative for an abnormal condition of the lubrication point.

11. The lubrication system according to claim 10, wherein the lubrication point is a bearing and wherein the at least one parameter includes temperature and/or vibration of the bearing.

12. The lubrication system according to claim 11, wherein the condition monitoring unit is configured to compare the value of the monitored parameter with a predefined threshold and is configured to determine that the condition of the respective lubrication point is abnormal when the value of the monitored parameter exceeds the predefined threshold.

13. The lubrication system according to claim 12, wherein the condition monitoring unit is configured to monitor the plurality of lubrication points continuously.

14. The lubrication system according to claim 13, wherein the control unit is configured to individually control each of the plurality of lubricant injectors to stop the transport of lubricant to the plurality of lubrication points outside the predefined lubrication cycles and to deliver an additional dose of lubricant to the lubrication point having an abnormal condition if required.

15. The lubrication system according to claim 14, wherein each of the plurality of lubricant injectors comprises a valve which is configured to be closed or opened by the control unit.

16. The lubrication system according to claim 15, wherein the control unit is configured to adjust the predefined lubrication cycles when the control unit determines over a predetermined time period that all lubrication points of the plurality of lubrication points require additional doses of lubricant outside the predefined lubrication cycle.

17. A lubrication method for lubricating a plurality of lubrication points, the method comprising:
controlling a plurality of lubricant injectors to deliver lubricant from a lubricant reservoir to a plurality of lubrication points in predefined lubrication cycles;
monitoring the condition of the plurality of lubrication points, and, when it is determined that the condition of at least one of the plurality of lubrication points is abnormal, controlling the lubricant injector being associated with the at least one of the plurality of lubrication points to deliver an additional dose of lubricant to the at least one of the plurality of lubrication points.
